(19) United States
(12) Patent Application Publication
(10) Pub. No.: US 2022/0291722 A1
(43) Pub. Date: Sep. 15, 2022

(54) ACCESSORY DOCKS WITH MOVEABLE HOLDERS

(71) Applicant: Hewlett-Packard Development Company, L.P., Spring, TX (US)

(72) Inventors: Hung Sung Pan, Taipei City (TW); Kuo Chih Huang, Taipei City (TW); Yung Yun Chen, Taipei City (TW)

(73) Assignee: Hewlett-Packard Development Company, L.P., Spring, TX (US)

(21) Appl. No.: 17/631,624

(22) PCT Filed: Sep. 30, 2019
(86) PCT No.: PCT/US2019/053742

§ 371 Date: Jan. 31, 2022

(51) Int. Cl. G06F 1/16

(52) U.S. Cl. CPC G06F 1/1656; G06F 1/1692

(57) ABSTRACT

In an example, an accessory dock may include a holder that is moveable between a stowed position disposed within a housing of a computing device and a deployed position extending out from the housing of the computing device. Further, the holder is to receive an accessory band of a device accessory when the holder is disposed in the deployed position so as to stow the device accessory on to an external portion of the housing of the computing device.

### BACKGROUND

Electronic devices such as computing devices may be utilized in various ways. In some situations, electronic devices may be interacted with by a user through various types of interfaces, for example, mice, trackpads, keyboards, etc. In some situations, electronic devices may include a display, which may be a touch screen display. A user may interact with a touch screen display by touching by hand, or by using an accessory, such as a stylus or electronic pen. A computing device may also employ communication components such as antennas to receive or transmit electromagnetic signals.

### BRIEF DESCRIPTION OF THE DRAWINGS

FIGS. 1A-D are partial perspective views of an example accessory dock.

FIG. 2A is a perspective view of an example computing device having an example accessory dock.

FIGS. 2B-C are detail perspective views of an example computing device having an example accessory dock.

FIG. 2D is a perspective view of an example accessory dock of the example computing device of FIGS. 2A-2C.

FIGS. 2E-F are perspective views of an example computing device having an example accessory dock.

FIGS. 3A-C are perspective views of an example computing device having an example accessory dock.

### DETAILED DESCRIPTION

As described above, electronic devices such as computing devices may be utilized in various ways. In some situations, electronic devices may be interacted with by a user through various types of interfaces, for example, mice, trackpads, keyboards, etc. In further situations, electronic devices may include a display on which content may be output or shown to a user. The display may be a standalone monitor or screen for a desktop computer in some examples, or may be an integrated screen, for example, in a laptop or notebook computer, or a tablet computer. Other examples may include a display or screen on a different type of electronic device, for example, an imaging device such as a printer, or an additive manufacturing machine such as a three-dimensional (3D) printer. In some situations, the display of an electronic device may be a touch screen display. A user may interact with a touch screen display by touching by hand, or by using an accessory, such as a stylus or electronic pen.

An accessory such as a stylus or electronic pen can be a useful tool in interacting with an electronic device such as a computer having a touch screen display. For example, such an accessory may be used to write notes on a display, mimicking a pad of paper or a sticky note, or may further be used to draw or sketch on a display in order to generate electronic drawings or graphic designs.

Such accessories are often stored separately from an electronic device, for example in a user's bag or pocket. Due to the relatively small size of the accessory, this can result in the user inadvertently losing the accessory, or not being able to locate the accessory among other items in the bag. Some electronic devices may include a slot or channel into which the stylus, electronic pen, or other accessory may be inserted in order to be stowed. This solution may take up valuable space or volume within the chassis of the electronic device, where space is often at a premium. Such methods of stowing an accessory may be cumbersome or ugly and not match the industrial design or aesthetics of the electronic device, may not hold the accessory securely enough to the electronic device, and/or may incur additional cost to the user. In other situations, the computing device may employ magnets to hold a device accessory towards the sideband. This solution may result in losing the stylus or other accessory when they are not in a good position. Further, using magnets to retain a device accessory may have negative effects on the performance of communication components of the electronic device, e.g., such magnets may also cause antenna interference.

In some situations, it may be desirable to employ an accessory dock with an electronic device that may securely hold an accessory, such as a stylus or electronic pen, while stowed, may occupy a minimum amount of internal volume of the chassis of the electronic device, and may have a discrete or favorable appearance, or may match the aesthetic or industrial design of the electronic device. Additionally, it may be desirable to employ an accessory dock that will avoid interference with communication components of the electronic device. Implementations of the present disclosure provide accessory docks with moveable holders that are discrete and blend in with the overall aesthetic of an electronic device, and that can securely hold an accessory of the electronic device when deployed. Further, accessory docks disclosed herein may occupy a minimum amount of internal volume of the electronic device. Additionally, accessory docks disclosed herein may not interfere with antennas or other communication components of the electronic device.

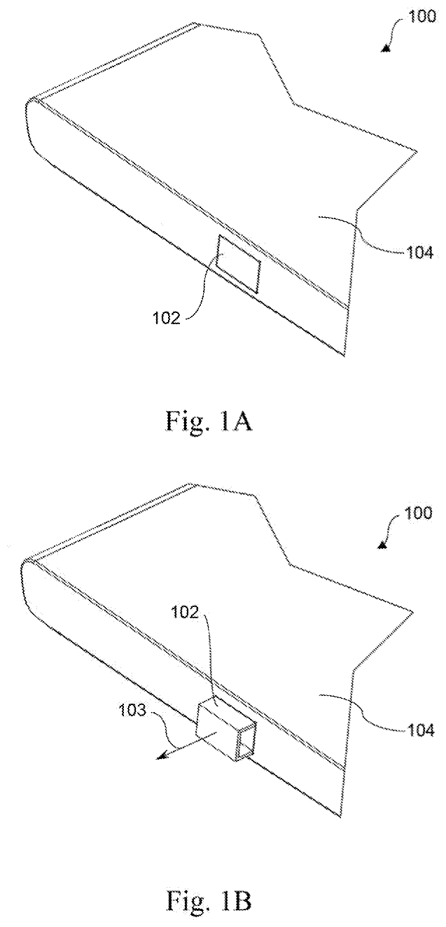

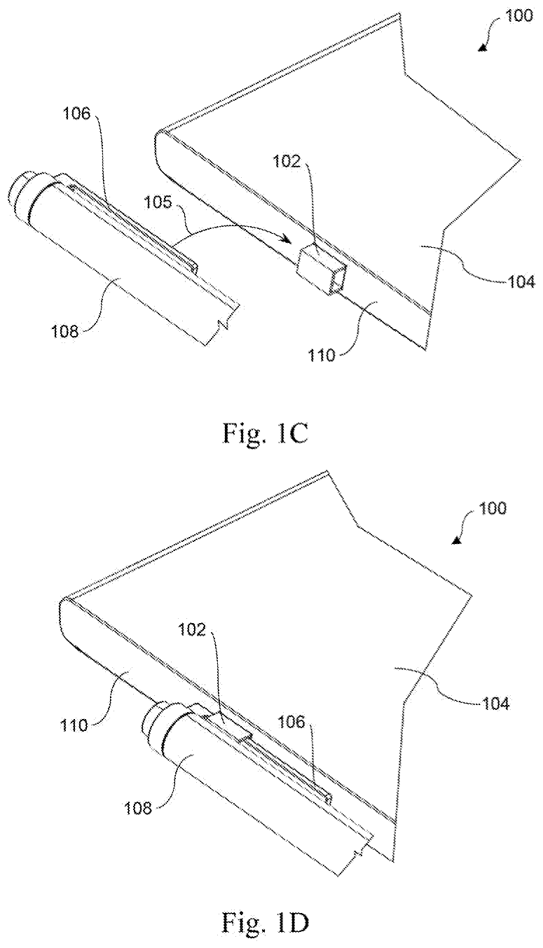

Referring now to FIG. 1A, a partial perspective view of an example accessory dock 100 is illustrated. Accessory dock 100 may include a holder 102 disposed within a housing 104 of a computing device. Holder 102 may be moveable between a stowed position, illustrated in FIG. 1A, and a deployed position, as shown and described below. Referring additionally to FIG. 1B, another perspective view of example accessory dock 100 is illustrated, wherein the holder 102 is disposed in the deployed position, extending from the housing 104 of the computing device. In order to transition from the stowed position to the deployed position, the holder 102 may move along example direction 103.

Referring now to FIG. 1C, another perspective view of example accessory dock 100 is illustrated. In some implementations, the holder 102 may receive an accessory band 106 of an accessory device 108 when the holder 102 is disposed in the deployed position. The holder 102 may receive the accessory band 106, for example, along direction 105, so as to stow the device accessory 108 on to an external portion 110 of the housing 104 of the computing device. Referring additionally to FIG. 1D, another perspective view of example accessory dock 100 is illustrated, wherein the holder 102 is engaged with an accessory band 106 of a device accessory 108 such that the device accessory 108 is stowed to the housing 104 of the computing device. Thus, when not in use, the holder 102, and thus the accessory dock 100, may be stowed in such a way so as to match and/or not detract from the aesthetic appearance or industrial design of the computing device, while, when desired, the holder 102 may be ejected to the deployed position to securely retain and hold on to a device accessory 108 so as to stow the device accessory 108.

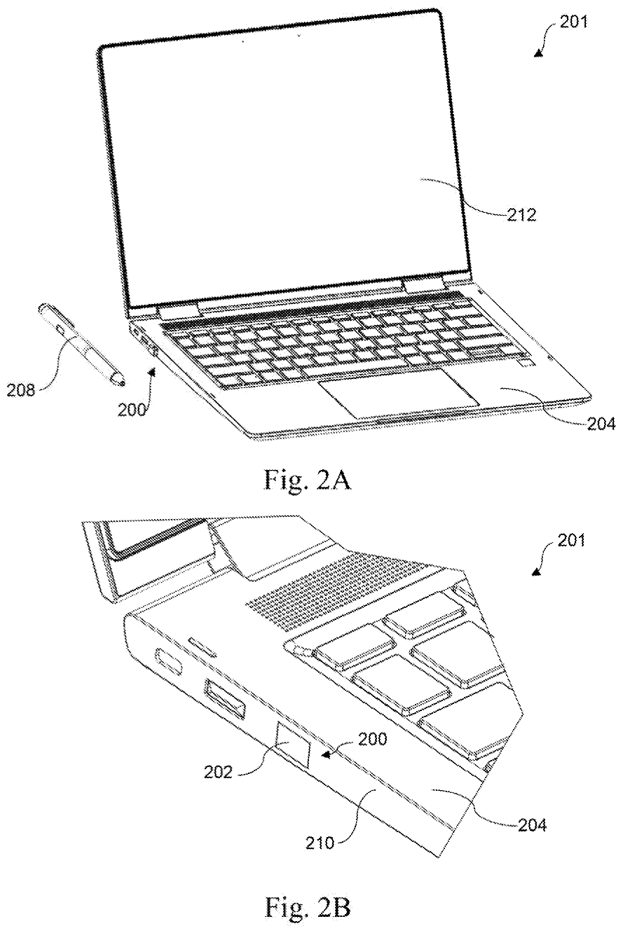

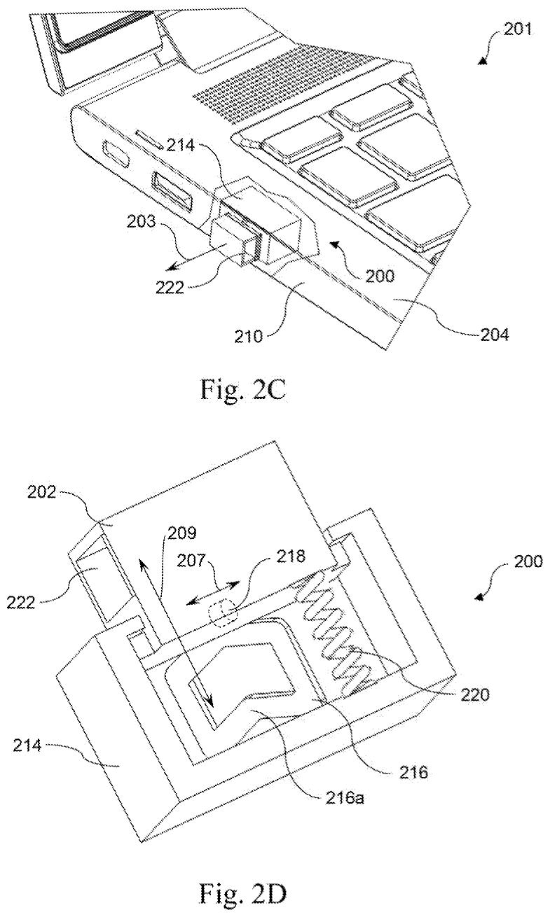

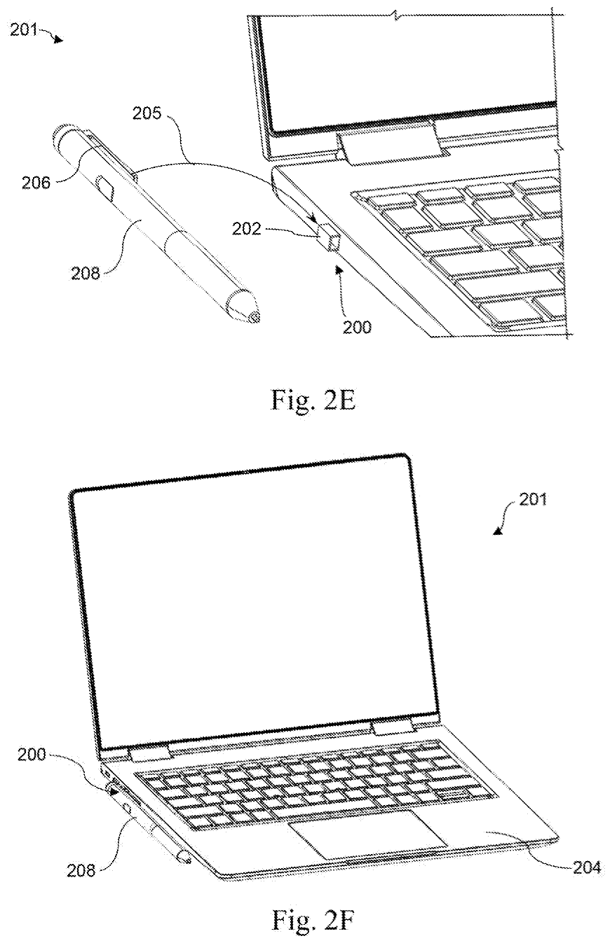

Referring now to FIG. 2A, a perspective view of an example computing device 201 having an example accessory dock 200 is illustrated. Example accessory dock 200 may be similar to example accessory dock 100, described above. Further, the similarly-named elements of example accessory dock 200 may be similar in function and/or structure to the respective elements of example accessory dock 100, as they are described above.

Computing device 201 may include a housing 204 to enclose and/or mechanically and electrically support computing components of the computing device. Such computing components may include processors, storage drives, memory, motherboards, or other suitable components for use in a computing device. Computing device 201 may include a display 212 which, in some examples, may be a touch screen display. Further, computing device 201 may also include a device accessory 208. The device accessory 208, in some examples, may be an electronic pen or stylus to be used with the touch screen display 212. In other examples, the display 212 may not be a touch screen display and the device accessory 208 may be a different type of accessory, e.g., a traditional pen or pencil, laser pointer, or another accessory. In some examples, computing device 201 may be a desktop personal computer (PC), a notebook PC or mobile workstation, a tablet, a smartphone, a convertible or 2-in-1 mobile device that may be utilized in either a clamshell mode or a tablet mode, or another type of computing device. In other examples, computing device 201 may be another device which may have a display and/or which may benefit from being used with a device accessory 208. Such other types of computing devices may include imaging devices such as printers or copiers, additive manufacturing machines or three-dimensional (3D) printers, or other types of devices.

Referring now to FIG. 2B, a detail perspective view of example computing device 201 is illustrated. Example accessory dock 200 may include a holder 202. In some implementations, the accessory dock 200 may be disposed within the housing 204 and/or on an exterior portion of the housing 204 such that the holder 202 may be moveable between a stowed position disposed within the housing so as to sit approximately flush with the exterior portion or exterior surface 210, and a deployed position, illustrated in FIG. 2C, extending out from the housing 204 and the exterior surface 210 thereof.

Referring additionally to FIG. 2C, another detail perspective view of the example computing device 201 is illustrated, showing the holder 202 in the deployed position. In order to transition from the stowed position to the deployed position, the holder 202 may be moved along example direction 203, towards an exterior of the housing 204. The holder 202 may be a rigid or semi-rigid component capable of structurally supporting the mass of an accessory device to be used with the computing device 201. The holder 202, in some examples, may have a tubular, either rectangular or otherwise, structure, so as to define a channel 222 within the holder 202. Upon being disposed in the deployed position, the holder 202 may expose the channel 222 to receive an accessory band of a device accessory. In other examples, the channel 222 may have a profile or geometry substantially matching a cross-section or other profile of an accessory band of the device accessory to be used with the computing device 201. As such, the channel 222 may be able to receive the accessory band through the length of the holder 202, thereby enabling the holder 202 to retain or stow the device accessory to the computing device 201.

The accessory dock 200 may further include a holder frame 214 fixed within the housing 204, and the holder 202 may be moveably disposed within the holder frame 214. The holder 202 may be disposed substantially within the holder frame 214 when in the stowed position, and may extend out of the holder frame 214 in the deployed position. The holder 202 may be able to move relative to the holder frame 214 such that, upon the holder 202 being transitioned between the stowed and the deployed position, the holder frame 214 is able to be fixed and stationary relative to the housing 204. Referring now to FIG. 2D, a perspective view of the example accessory dock 200 is illustrated. The holder frame 214 may be able to structurally support and define the extent of movement that the holder 202 is able to undergo, e.g., along direction 209. For example, a number of tabs, shelves, shoulders, ledges, or other mechanical structures may be employed between the holder 202 and the holder frame 214 to both retain the holder 202 in engagement with the holder frame 214, and to also determine the extent to which the holder 202 may extend beyond the exterior surface 210 of the housing 204 when in the deployed position.

In some implementations, the holder 202 may be ejectable from the stowed position to the deployed position, and retainable in the stowed position from the deployed position, using a push-push mechanism. In other words, the holder 202 may be transitioned to and held in the stowed position upon being pushed from the deployed position towards the stowed position, e.g., opposite to direction 203, and the holder 202 may also transition from the stowed position to the deployed position upon being pushed from the stowed position further towards the stowed position. Further pushing the holder 202 towards the stowed position when in the stowed position may unlock the push-push mechanism and allow the holder 202 to then eject and transition to the deployed position.

In some examples, the accessory dock 200 may further include a bias member 220 disposed within the holder frame 214 (or between an inside edge of the holder frame 214 and the holder 202). The bias member 220 may be a resilient component capable of undergoing elastic deformation. I.e., the bias member 220 may be able to return to its starting shape after undergoing a deformation, and may be able to exert a reactionary force proportional to such deformation. The bias member 220 may urge or exert a reactionary force against the holder 202 in a direction towards the deployed position. In some implementations, the bias member 220 may be a coil spring, or another type of spring.

In some examples, the holder frame 214 includes a control path 216 and the holder 202 includes a control pin 218. The control pin 218 may be sized, structured, and/or positioned so as to travel within the control path 216 throughout the travel of the holder 202 between the stowed and deployed positions. In some examples, as the holder 202 is moved along direction 205, the control path 216 may cause the control pin 218 to move side-to-side along direction 207 so as to follow the control path 216. The control path 216, the control pin 218, and the bias member 220 may define a push-push mechanism to retain the holder 202 in the stowed position and to eject the holder 202 to the deployed position when the push-push mechanism is actuated (pushing the holder 202 towards the stowed position, against the urging of the bias member 220). The control pin 218 may move along the control path 216 until it reaches a retention portion 216a at the back of the control path 216 when the holder 202 reaches the stowed position. The bias member 220 may hold the control pin 218 in the retention portion 216a such that the control pin 218 retains the holder 202 in the stowed position. Upon being actuated, the push-push mechanism may allow the control pin 218 to further travel along the control path 216 to leave the retention portion 216a and unlock the holder 202. Thus, the bias member 220 may be able to eject the holder 202 to the deployed position upon the push-push mechanism being actuated. In further implementations, the accessory dock 200 may include a plurality of bias members disposed within the holder frame 214 to urge the holder 202 in a direction towards the deployed position.

Referring now to FIG. 2E, a perspective view of computing device 201 is illustrated, wherein the push-push mechanism has been actuated, and the holder 202 has transitioned to the deployed position, exposing channel 220 to an exterior of the computing device 201. A device accessory 208 may be stowed on to the computing device 201, or an exterior surface thereof, by inserting the accessory band 206 into the holder 202, or the channel 222 thereof, e.g., along direction 205. Referring additionally to FIG. 2F, a perspective view of the computing device 201 is illustrated, wherein the device accessory 208 is stowed on to the computing device 201. The holder 202 may retain or hold on to the accessory band to a sufficient degree, or with a sufficient amount of tightness or grip, so as to securely hold the device accessory 208 to the computing device 201.

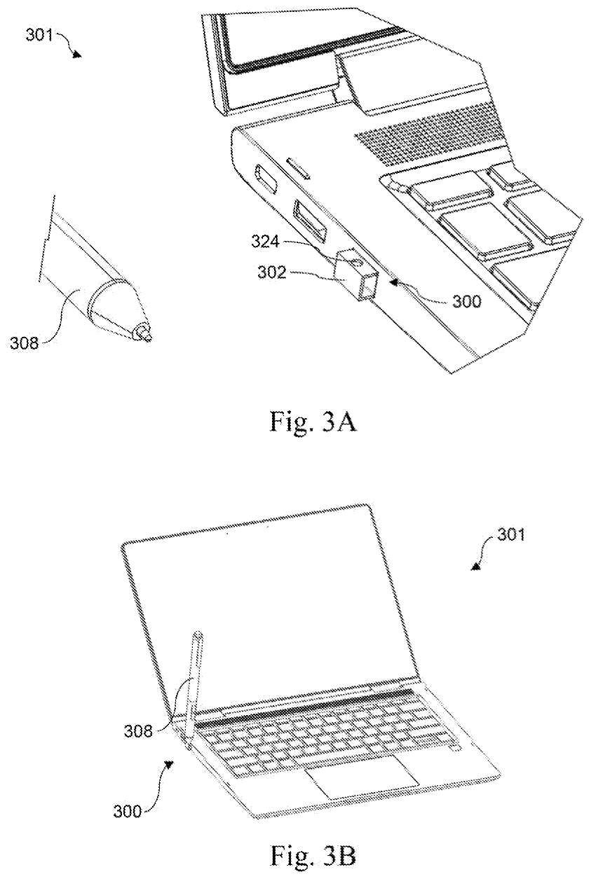

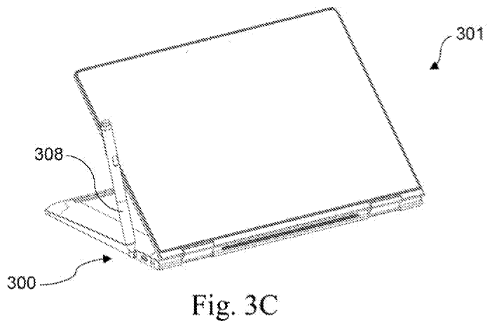

Referring now to FIG. 3A, a perspective view of an example computing device 301 having an example accessory dock 300 is illustrated. Example accessory dock 300 may be similar to other example accessory docks described above. Further, the similarly-named elements of example accessory dock 300 may be similar in function and/or structure to the respective elements of other example accessory docks, as they are described above.

Example accessory dock 300 may include a holder 302 to receive a device accessory 308. The holder 302 may include an accessory aperture 324 extending through the holder 302. The holder 302 may expose the accessory aperture 324 when the holder 302 is in the deployed position. Similarly, the accessory aperture 324 may be concealed within the housing of the computing device 301 when the holder 302 is disposed in the stowed position to maintain the positive aesthetic and/or industrial design of the computing device 301. The accessory aperture 324 may have a sufficient size and structure so as to be able to receive a portion, e.g., a tip, of the device accessory 308 when the accessory aperture is exposed. Referring additionally to FIG. 3B, another perspective view of the example computing device 301 is illustrated wherein the device accessory 308 is engaged with the accessory aperture 324. It may sometimes be desired to temporarily stow the device accessory 308 when it is not being used, but to ensure that it is easily retrievable at any time. The accessory aperture 324 may receive a portion of the device accessory 308 so as to hold the device accessory 308 in an upright position adjacent the computing device 301, and thus stow the device accessory 308 in an easily-retrievable position. Referring additionally to FIG. 3C, another perspective view of the computing device 301 is illustrated wherein the computing device 301 is being utilized in a tablet or presentation mode, as opposed to a clamshell mode illustrated in FIG. 3B. In such an example, the accessory aperture 324 may extend through an entire thickness of the holder 302 such that the accessory aperture 324 may be engaged with the device accessory 308 from a top side (illustrated in FIG. 3B) and a bottom side (illustrated in FIG. 3C). Thus, the accessory aperture 324 may be able to stow the device accessory 308 in a convenient and easily-retrievable manner when the computing device 301 is disposed in a variety of configurations.

What is claimed is:

1. An accessory dock, comprising:
a holder that is moveable between a stowed position disposed within a housing of a computing device and a deployed position extending out from the housing of the computing device,
wherein the holder is to receive an accessory band of a device accessory when the holder is disposed in the deployed position so as to stow the device accessory on to an external portion of the housing of the computing device.

2. The accessory dock of claim 1, wherein the holder is to be transitioned to and held in the stowed position upon being pushed from the deployed position towards the stowed position, and the holder is to transition from the stowed position to the deployed position upon being pushed from the stowed position further towards the stowed position.

3. The accessory dock of claim 2, wherein the holder is disposed within a holder frame fixed within the housing of the computing device, the holder to move relative to the holder frame upon being transitioned between the stowed position and deployed position.

4. The accessory dock of claim 3, wherein the holder frame includes a control path and the holder includes a control pin, the control pin to travel along the control path such that the control path is to retain the holder in the stowed position.

5. The accessory dock of claim 1, wherein the holder comprises an accessory aperture that is disposed outside of the housing of the computing device when the holder is disposed in the deployed position, the accessory aperture to receive a portion of the device accessory so as to hold the device accessory in an upright position adjacent the computing device.

6. The accessory dock of claim 5, wherein the accessory aperture is concealed within the housing of the computing device when the holder is disposed in the stowed position.

7. The accessory dock of claim 1, wherein the holder is to sit substantially flush with an exterior surface of the housing when the holder is disposed in the stowed position.

8. A housing for a computing device, comprising:
an accessory dock disposed on an exterior portion of the housing and comprising:
a holder movable between a stowed position disposed within the housing and a deployed position extending from the exterior portion, the holder to expose a channel to receive an accessory band of a device accessory when disposed in the deployed position;
a holder frame fixed within the housing, the holder moveably disposed within the holder frame; and
a bias member disposed within the holder frame to urge the holder in direction towards the deployed position.

9. The housing of claim 8, wherein the channel of the holder is to receive the accessory band so as to retain the device accessory to the exterior portion of the housing.

10. The housing of claim 9, wherein the holder frame includes a control path and the holder includes a control pin, wherein the control path, the control pin, and the bias member define a push-push mechanism to retain the holder in the stowed position, and to eject the holder to the deployed position when actuated.

11. The housing of claim 10, wherein the bias member is to move the holder from the stowed position to the deployed position upon the push-push mechanism being actuated.

12. The housing of claim 10, wherein the accessory dock includes a plurality of bias members disposed within the holder frame to urge the holder in a direction towards the deployed position.

13. A computing device, comprising:
a touch-screen display;
a housing to enclose computing components of the computing device;
a device accessory; and
an accessory dock disposed within the housing, comprising:
a holder frame fixed within the housing; and
a holder disposed within and moveable relative to the holder frame between a stowed position within the holder frame and housing and a deployed position extending out of the holder frame and housing,
wherein, when disposed in the deployed position, the holder is to receive an accessory band of the device accessory so as to stow the device accessory on to an exterior portion of the computing device.

14. The computing device of claim 13, wherein the holder includes a channel to receive the accessory band of a device accessory when the holder is in the deployed position so as to stow the device accessory to the computing device.

15. The computing device of claim 12, wherein the device accessory is a stylus to be used with the touch-screen display.
